(19) United States
(12) Patent Application Publication
(10) Pub. No.: US 2016/0054963 A1
(43) Pub. Date: Feb. 25, 2016

(54) MANAGEMENT SYSTEM AND CONTROL METHOD

(71) Applicant: CANON KABUSHIKI KAISHA, Tokyo (JP)

(72) Inventor: Yoshinobu Hamada, Yokohama-shi (JP)

(21) Appl. No.: 14/828,958

(22) Filed: Aug. 18, 2015

(30) Foreign Application Priority Data
Aug. 22, 2014 (JP) 2014-169271
Jan. 23, 2015 (JP) 2015-011530

(51) Int. Cl. G06F 3/12; H04L 29/08; H04N 1/00; H04L 12/24

(52) U.S. Cl. CPC G06F 3/1273; H04L 41/046; H04L 67/1097; H04L 67/1014; G06F 3/126; G06F 3/1238; G06F 3/1222; G06F 3/121; G06F 3/1234; H04N 1/0009; H04N 1/00061; H04N 1/00015; H04N 2201/0094

(57) ABSTRACT

A request processing unit in a job history processing server requests, when it receives a request to reserve data transfer including an agent ID, first agent information corresponding to the agent ID of an agent management unit, requests second agent information of an MFP when it cannot acquire the first agent information from the agent management unit, and stores the requested second agent information in a temporary agent management unit. The request processing unit exports data accepted from a collection agent after the second agent information is stored, together with the second agent information, to a storage area that can be referred to by a job history audit system.

### BACKGROUND OF THE INVENTION

1. Field of the Invention

The present invention relates to control of a system that accepts data to be collected from an agent, which operates on a network device, such as an image forming apparatus or an information processing apparatus.

2. Description of the Related Art

Conventionally, a job history processing system that collects history information about a job such as printing, which has been performed by a printer or a multifunction peripheral (MFP), for the purpose of suppressing leakage of information or tracking a leaker of information has been developed.

The job history processing system includes a collection agent that collects a job history on the MFP or a personal computer (PC), and a job history processing server that receives the job history from the collection agent, processes and converts the received job history, and transfers the processed and converted job history to a job history audit system for storing and auditing the job history.

The job history processing server manages setting information about each of the collection agents, including information about the MFP or the PC on which the collection agent operates. The job history processing server adds the setting information about the collection agent, which has transmitted the job history, to the received job history so that a source of the job history and setting of the collection agent during generation of the job history can be confirmed later.

In the job history processing system, in a large-scale environment to which job histories in large amounts are transmitted, a plurality of job history processing servers may be provided, and a load balancer may distribute a processing load among the job history processing servers. In a system having such a load distribution configuration, a common management service for managing setting information about each of the collection agents is provided on a network, and each of the job history processing servers accesses the management service, to acquire the setting information about the collection agent.

Japanese Patent Application Laid-Open No. 11-184745 discusses a technique for more enhancing performance and reliability in a system that distributes a load. Japanese Patent Application Laid-Open No. 11-184745 discusses a technique of managing, when a plurality of servers has a distributed database, accessibility to the distributed database by each of the servers using a flag and reducing a network load by retrying data access when the distributed database is inaccessible. In the job history processing system having the load balancer, the setting information about each of the collection agents managed by the management service needs to be accessed as common information from the job history processing servers, unlike that in the distribution configuration that can adopt the technique discussed in Japanese Patent Application Laid-Open No. 11-184745. When the management service for managing the setting information about the collection agent has been down due to any cause, then, the setting information about the collection agent cannot be added to the job history in each of the job history processing servers. Thus, any one of the job history processing servers cannot transfer the job history to the job history audit system. Therefore, if a fault in the management service is prolonged, the immediacy of an audit is deteriorated, and the discovery of leakage of information is delayed.

Even if the job history processing server has a single configuration, only a management function about the collection agent setting information in the management service or the job history processing service cannot be temporarily used. Therefore, a similar problem may occur.

### SUMMARY OF THE INVENTION

The present invention is directed to providing a mechanism capable of promptly transferring a job history to an external system such as a job history audit system even when a fault occurs in a service for managing information about an agent, for example, and maintaining the immediacy of an audit of the job history.

According to an aspect of the present invention, a management system that accepts data to be collected via a load balancer from an agent, which operates on a network device includes a receiving unit configured to receive a request to reserve data transfer including identification information about the agent, a first request unit configured to request first agent information corresponding to the identification information included in the request to reserve data transfer of an agent management service, a second request unit configured to request second agent information of the network device when the first agent information cannot be acquired from the agent management service, a storage unit configured to store the second agent information acquired from the network device, and an export unit configured to export data accepted from the network device after the second agent information is stored, together with the second agent information, to a storage area that can be referred to by an external system.

Further features of the present invention will become apparent from the following description of exemplary embodiments with reference to the attached drawings.

### BRIEF DESCRIPTION OF THE DRAWINGS

FIG. 1 is a system configuration diagram of a first exemplary embodiment.

FIG. 2 illustrates a hardware configuration of a multifunction peripheral (MFP).

FIG. 3 illustrates a hardware configuration of a job history processing server and an agent management server.

FIG. 4 illustrates a software configuration of an MFP.

FIG. 5 illustrates a software configuration of a job history processing server and an agent management server.

FIG. 6 is a flowchart of processing for transmitting a job history by a collection agent according to the first exemplary embodiment.

FIG. 7 is a diagram including the flowcharts of FIGS. 7A and 7B illustrating processing for receiving a processing request by a job history processing server according to the first exemplary embodiment.

FIG. 8 is a flowchart of processing for detecting whether a job history processing server has been restored.

FIG. 9 is a system configuration diagram of a second exemplary embodiment.

FIG. 10 is a flowchart of processing for transmitting a job history by a collection agent according to the second exemplary embodiment.

FIG. 11 is a diagram including the flowcharts of FIGS. 11A and 11B illustrating processing for receiving a processing request by a job history processing server according to the second exemplary embodiment.

FIG. 12 illustrates a file storing an agent management unit fault flag.

FIGS. 13A and 13B illustrate data stored in a job history receiving area.

FIG. 14 illustrates a file storing a server fixing flag.

FIG. 15 is a flowchart of processing for issuing a notification that a job history processing server has been started, according to a third exemplary embodiment.

FIG. 16 is a flowchart of processing for receiving a start notification of the job history processing server, according to the third exemplary embodiment.

FIG. 17 is a diagram including the flowcharts of FIGS. 17A and 17B illustrating processing for receiving a processing request by the job history processing server, according to the third exemplary embodiment.

FIG. 18 is a flowchart of processing for issuing a notification that a job history processing server has been started, according to a fourth exemplary embodiment.

FIG. 19 is a flowchart of processing for receiving a notification of the number of collection agents per one of job history processing servers, according to the fourth exemplary embodiment.

### DESCRIPTION OF THE EMBODIMENTS

Exemplary embodiments of the present invention will be described below with reference to the drawing.

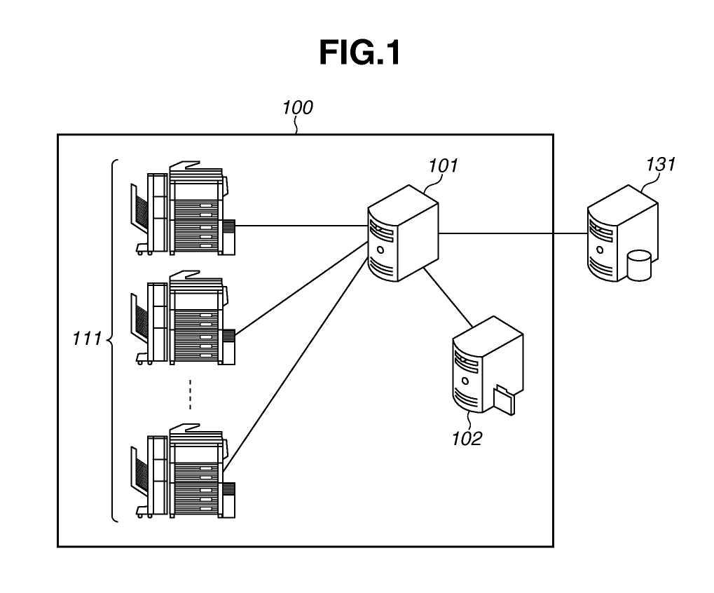

FIG. 1 illustrates a configuration of a job history processing system 100 according to a first exemplary embodiment of the present invention and a job history audit system 131 associated with the job history processing system 100. In the job history processing system 100 according to the present exemplary embodiment, a job history processing server 101, an agent management server 102, and a plurality of MFPs 111 are connected to one another.

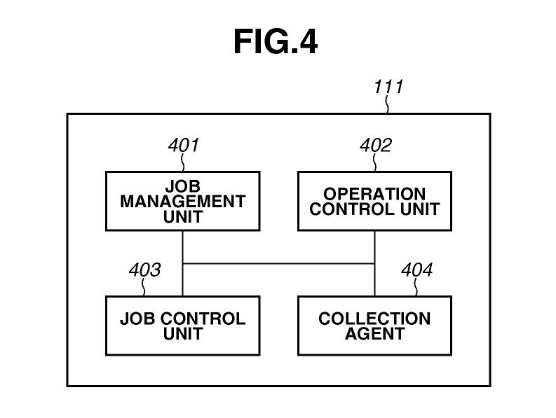

The job history processing server 101 is a management system that receives a job history serving as an execution record of a job (a copy job, a print job, etc.) executed by each of the MFPs 111, from a collection agent 404 (illustrated in FIG. 4, described below) that operates on the MFP 111. The job history is job log information, executed by the MFP 111, including an image to be input or output depending on a job type (a job history image) and job history attribute information including information about an execution date and time and an execution user of the job, and is recorded by the MFP 111. Further, the job history processing server 101 performs processing such as shaping of data included in the received job history and resolution conversion of a jog history image, as needed, adds, to a processing result, setting information about the collection agent 404 serving as a transmission source of the job history, and transmits the processing result to the job history audit system 131 associated therewith.

The agent management server 102 manages setting information about the collection agent 404, to be described below, operating on each of the MFPs 111. The job history processing server 101 acquires the setting information about the collection agent 404 from the agent management server 102. The agent management server 102 may be included in the job history processing server 101.

The job history audit system 131 generally has a data storage and search function for auditing a job history, and may be a system tailored specifically for the audit of the job history, or a general data warehouse system or document management system.

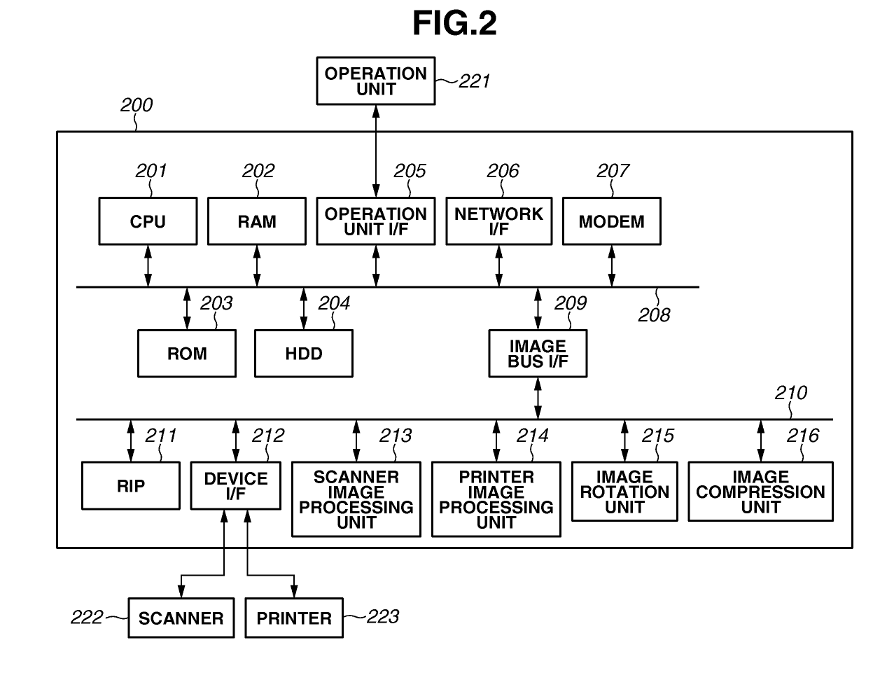

FIG. 2 is a block diagram illustrating a hardware configuration of the MFP 111.

In FIG. 2, a controller unit 200 is connected to a scanner 222 and a printer 223 and a network and a public line, to input and output image data and device information.

In the controller unit 200, a central processing unit (CPU) 201 controls the entire MFP 111. A random access memory (RAM) 202 is a work memory for the CPU 201 to operate while being an image memory for temporarily storing input image data. A read-only memory (ROM) 203 is a boot ROM, and stores a boot program for the system. A hard disk drive (HDD) 204 stores system software, a job history, and image data in a user box. The HDD 204 may be replaced with a storage device such as a solid state drive (SSD).

An operation unit interface (I/F) 205 is an interface to an operation unit 221, and outputs screen data displayed on the operation unit 221 to the operation unit 221. A network I/F 206 is connected to the network such as a local area network (LAN), to input and output information. A modem 207 is connected to the public line, to input and output image data. The foregoing devices are arranged on a system bus 208.

An image bus I/F 209 is a bus bridge that is connected to the system bus 208 and an image bus 210 that transfers image data at high speed to each other, to convert a data structure. The following devices are arranged on the image bus 210.

A raster image processor (RIP) 211 rasterizes a page description language (PDL) code into a bit map image. A device I/F 212 connects, to the controller unit 200, the scanner 222 and the printer 223 each serving as an image input/output device, to convert image data.

A scanner image processing unit 213 performs correction, processing, and editing for input image data. A printer image processing unit 214 performs printer correction and resolution conversion for output image data. An image rotation unit 215 rotates image data. An image compression unit 216 performs compression/decompression processing for image data.

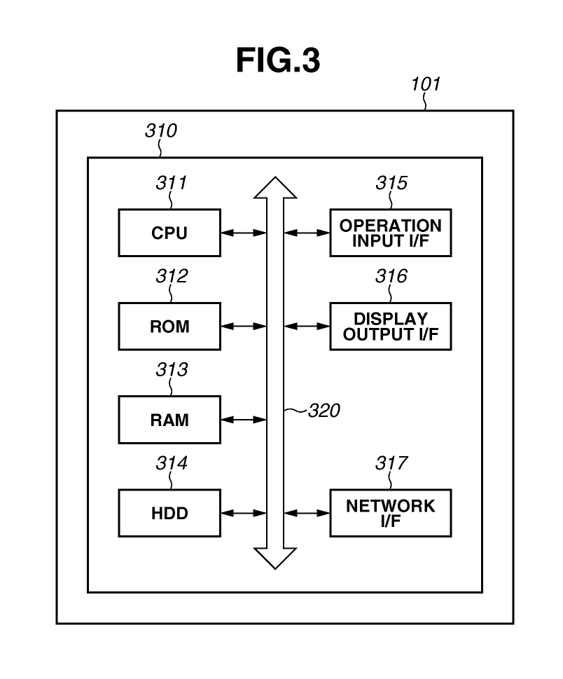

FIG. 3 is a block diagram illustrating a hardware configuration of the job history processing server 101 or the agent management server 102.

A control unit 310 including a CPU 311 controls an operation of a server apparatus. The CPU 311 reads out a control program stored in a ROM 312 or a HDD 314, and performs various types of control processing such as input and output and calculation processing. A RAM 313 is used as a temporary storage area such as a main memory or a work area of the CPU 311. The HDD 314 stores a job history and various programs. The HDD 314 may be replaced with another storage device such as a solid state drive (SSD).

An operation input I/F 315 accepts input of a signal from an operation device such as a keyboard or a mouse connected thereto. A display output I/F 316 outputs a signal to a display for screen display. A network I/F 317 connects the control unit 310 to the network, and transmits and receives information to and from another apparatus on the network. A bus 320 connects blocks in the control unit 310 to one another.

FIG. 4 is a block diagram illustrating a software configuration of the MFP 111. A job management unit 401, an operation control unit 402, a job control unit 403, and the collection agent 404 illustrated in FIG. 4 are mounted as programs stored in the ROM 203 or the HDD 204 in the MFP 111, and function when the CPU 201 in the MFP 111 executes the programs.

The job management unit 401 executes a job accepted by the operation control unit 402 and a job accepted via the network, records a job history (a job history image and job history attribute information) on the HDD 204, and manages a status of the job. An example of the job history attribute information recorded by the job management unit 401 is illustrated in Table 1.

TABLE 1

| Attribute Item | Attribute Value |
|---|---|
| Job Type | Printing |
| Execution User Name | User A |
| Execution Date and Time | 2014/05/01 13:15:24 |
| Execution Result | Normal Exit |
| Communication Destination | |

In Table 1, “Attribute Value” corresponding to “Job Type” represents the type of job such as printing, copying, and facsimile (FAX) transmission. “Attribute Value” corresponding to “Execution User Name” represents a name of a user who has executed the job. “Attribute Value” corresponding to “Execution Date and Time” represents a date and time on which the job has been executed. “Attribute Value” corresponding to “Execution Result” represents an execution result of the job, i.e., normal exit or error exit. In the error exit, an error code may be recorded. “Attribute Value” corresponding to “Communication Destination” represents a number or an address for identifying a transmission destination or a transmission source in “Job Type” with communication such as FAX transmission, FAX reception, and mail transmission, and is blank (a state where there is no data) in “Job Type” (e.g., printing) with no communication destination. The job management unit 401 issues an instruction to the job control unit 403 depending on a processing content of the job.

The operation control unit 402 displays an operation screen on a display panel included in the operation unit 221, accepts input information about an operation performed by the operation unit 221, and transmits information to another functional unit, as needed. The operation control unit 402 controls a remote operation (a remote user interface (UI)) via the network.

The job control unit 403 operates the scanner 222 and the printer 223 according to an instruction from the job management unit 401. The job control unit 403 notifies the job management unit 401 of statuses of the scanner 222 and the printer 223.

The collection agent 404 acquires the job history recorded on the HDD 204, and transmits the acquired job history to the job history processing server 101. A specific operation of the collection agent 404 will be described below.

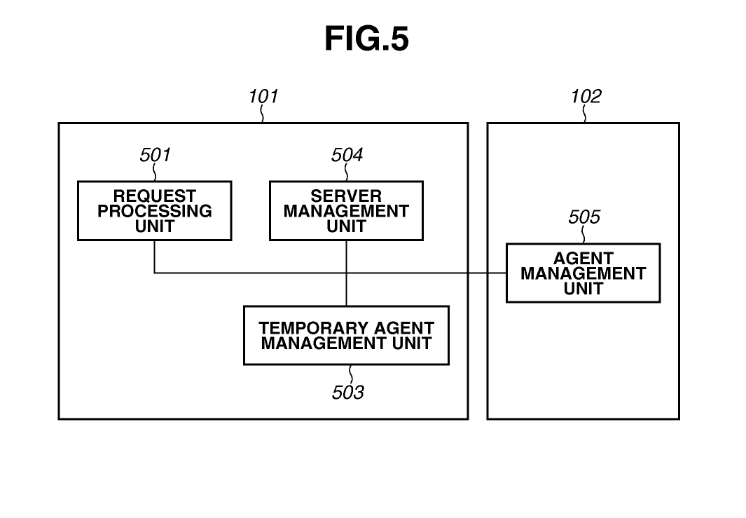

FIG. 5 is a block diagram illustrating a software configuration of the job history processing server 101 and the agent management server 102. A request processing unit 501, a server management unit 504, and a temporary agent management unit 503 illustrated in FIG. 5 are mounted as programs stored in the HDD 314 in the job history processing server 101, and function when the CPU 311 in the job history processing server 101 executes the programs. An agent management unit 505 is mounted as a program stored in the HDD 314 in the agent management server 102, and functions when the CPU 311 in the agent management server 102 executes the program.

The request processing unit 501 receives a processing request such as job history transmission from the collection agent 404 in the MFP 111, and performs processing, as needed. The request processing unit 501 performs, when it receives a job history, processing such as text extraction by Optical Character Recognition (OCR), image format conversion, and resolution conversion for an image included in the job history. The request processing unit 501 may generate a thumbnail of the image and shape job history attribute information in response to the job history audit system 131 to be associated. The request processing unit 501 adds agent setting information about the collection agent 404 of a transmission source of the job history processed as described above to the job history, and transmits the added setting information to the job history audit system 131. The request processing unit 501 may output the job history to which the agent setting information has been added to the HDD 314 in the job history processing server 101 and an export area such as an external file server (a storage area that can be referred to by the external system such as the job history audit system 131), in accordance with setting. More specifically, the request processing unit 501 exports data processed depending on acceptance needs from the collection agent 404, together with the agent setting information about the collection agent 404, to the storage area that can be referred to by the external system such as the job history audit system 131.

The temporary agent management unit 503 temporarily manages the agent setting information when the agent management unit 505, to be described below, cannot be used, and exchanges the agent setting information between the request processing unit 501 and itself, as needed. In the present exemplary embodiment, the temporary agent management unit 503 is a folder on a file system in the job history processing server 101. However, the present invention is not limited to this.

The server management unit 504 always operates, and detects, in a case where a fault occurs in the agent management unit 505, whether the fault has been restored.

The agent management unit 505 supports an agent management service for managing the setting information about the collection agent 404, which operates on the MFP 111 connected to the job history processing server 101, and exchanging the agent setting information between the request processing unit 501 and itself, as needed. While the agent management unit 505 is implemented by a database in the present exemplary embodiment, the present invention is not limited to this. In the present exemplary embodiment, the agent management unit 505 may exist on the job history processing server 101, although on the agent management server 102.

An operation of the collection agent 404 in the MFP 111 illustrated in FIG. 4 will be described below. The collection agent 404 accepts input of information for communicating with the job history processing server 101 from a system administrator prior to an operation for transmitting a job history to the job history processing server 101. For example, the collection agent 404 accepts input of an internet protocol (IP) address of the job history processing server 101 or an IP address of a load balancer in a second exemplary embodiment, to be described below. The collection agent 404 transmits agent setting information owned by itself to the request processing unit 501 in the job history processing server 101, and registers the transmitted agent setting information in the agent management unit 505. An example of the agent setting information is illustrated in Table 2.

TABLE 2

| Setting Item | Setting Value |
|---|---|
| Agent ID | |
| Apparatus Name | Development Unit MFP 1 |
| Product Model Number | abc100ef |
| Product Serial Number | 1234567890 |
| IP Address | 192.168.1.10 |
| MAC Address | XX-XX-XX-XX-XX-XX |
| Job History Transmission Interval | 10 min. |

As illustrated in Table 2, the agent setting information is agent information including “Agent ID” serving as identification information about the collection agent 404, “Apparatus Name” of the MFP 111, “Product Model Number”, “Product Serial Number”, “IP Address”, “Media Access Control (MAC) Address”, and “Job History Transmission Interval”. “Agent ID”, “Apparatus Name”, “Product Model Number”, “Product Serial Number”, “IP Address”, “MAC Address”, and “Job History Transmission Interval” included in the agent setting information are information for enabling setting of a source of a job history or an agent during job history generation to be confirmed later.

When the agent setting information is registered, the collection agent 404 accepts an agent ID for identifying itself issued by the agent management unit 505, and stores the received agent ID, which has been added to agent setting information owned by itself, on the HDD 204. Table 2 represents the agent setting information that has not been registered. When an agent ID “0001” is issued by the registration, “0001” is set as a setting value of “Agent ID” illustrated in Table 2.

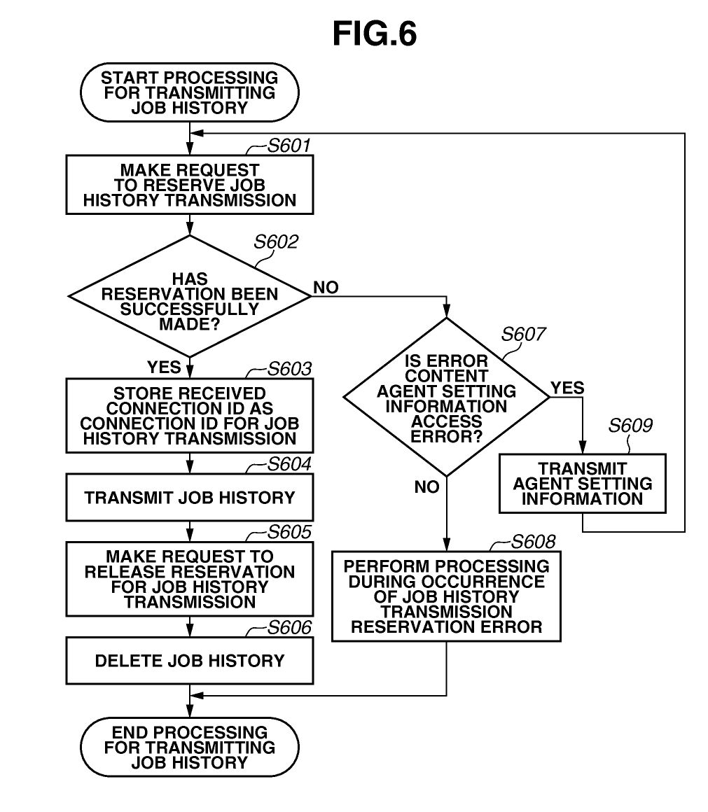

After the above described agent setting information has been registered, the collection agent 404 confirms whether job histories recorded on the HDD 204 exist at a time interval previously set (“Job History Transmission Interval” illustrated in Table 2), and transmits, when the job histories exist, the job histories one at a time to the job history processing server 101. This will be described below with reference to FIG. 6.

FIG. 6 is a flowchart illustrating an operation performed when the collection agent 404 transmits a job history to the job history processing server 101 in the first exemplary embodiment. Each of steps illustrated in the flowchart of FIG. 6 is implemented when the CPU 201 in the MFP 111 executes a program for implementing the collection agent 404 stored in the ROM 203 or the HDD 204. The CPU 201 uses the RAM 202 or the HDD 204 as a storage area, as needed. The flowchart of FIG. 6 illustrates processing for transmitting one job history. If there is a plurality of job histories in the HDD 204, the processing illustrated in FIG. 6 is repeated by the number of job histories in the HDD 204.

In step S601, the collection agent 404 requests the request processing unit 501 in the job history processing server 101 to reserve job history transmission. In the collection agent 404, the request to reserve the job history transmission includes an agent ID (identification information about the collection agent 404), and corresponds to a request to reserve data transfer from the collection agent 404 to the job history processing server 101.

In step S602, the collection agent 404 then receives a response to the reservation for the job history transmission, confirms its content, and determines whether the reservation has been successfully made. The collection agent 404 determines that the reservation has been successfully made if the response to the reservation for the job history transmission includes a connection ID. If the collection agent 404 determines that the reservation has been successfully made (YES in step S602), the processing proceeds to step S603.

In step S603, the collection agent 404 temporarily stores the connection ID included in the response indicating that the job history transmission has been successfully reserved, in the RAM 202 as a connection ID for job history transmission.

In step S604, the collection agent 404 then transmits the job history to be transmitted, which is stored on the HDD 204, to the request processing unit 501. In the transmission, the collection agent 404 transmits the job history, including the connection ID for job history transmission that has been stored in step S603. This is because the job history transmission is divided into a plurality of times of job history transmission depending on a content of the job history and the connection ID causes the job history processing server 101 to identify the plurality of times of job history transmission obtained by the division as those for the same job history.

In step S605, the collection agent 404 then requests the request processing unit 501 to release the reservation for the job history transmission. At this time, the collection agent 404 also transmits the request to release the reservation for the job history transmission, including the connection ID for the job history transmission, like in step S604.

In step S606, the collection agent 404 then deletes the job history which has been transmitted, from the HDD 204, and the processing ends.

If the collection agent 404 determines that the reservation has been unsuccessfully made (NO in step S602), the processing proceeds to step S607. In step S607, the collection agent 404 determines whether an error content indicating that the job history has been unsuccessfully reserved is an agent setting information access error. The collection agent 404 determines that the error content indicating that the job history transmission has been unsuccessfully reserved is the agent setting information access error when the response to the reservation for the job history transmission includes information representing the agent setting information access error.

If the collection agent 404 determines that the error content indicating that the job history transmission has been unsuccessfully reserved is not the agent setting information access error (NO in step S607), the processing proceeds to step S608. In step S608, the collection agent 404 records the error content in its own operation log as processing during occurrence of a job history transmission reservation error, and the processing ends.

On the other hand, if the collection agent 404 determines that the error content indicating that the job history transmission has been unsuccessfully reserved is the agent setting information access error (YES in step S607), the processing proceeds to step S609. In step S609, the collection agent 404 reads out agent setting information owned by itself stored on the HDD 204, and transmits the read agent setting information to the request processing unit 501 in the job history processing server 101. After the transmission, the processing proceeds to step S601.

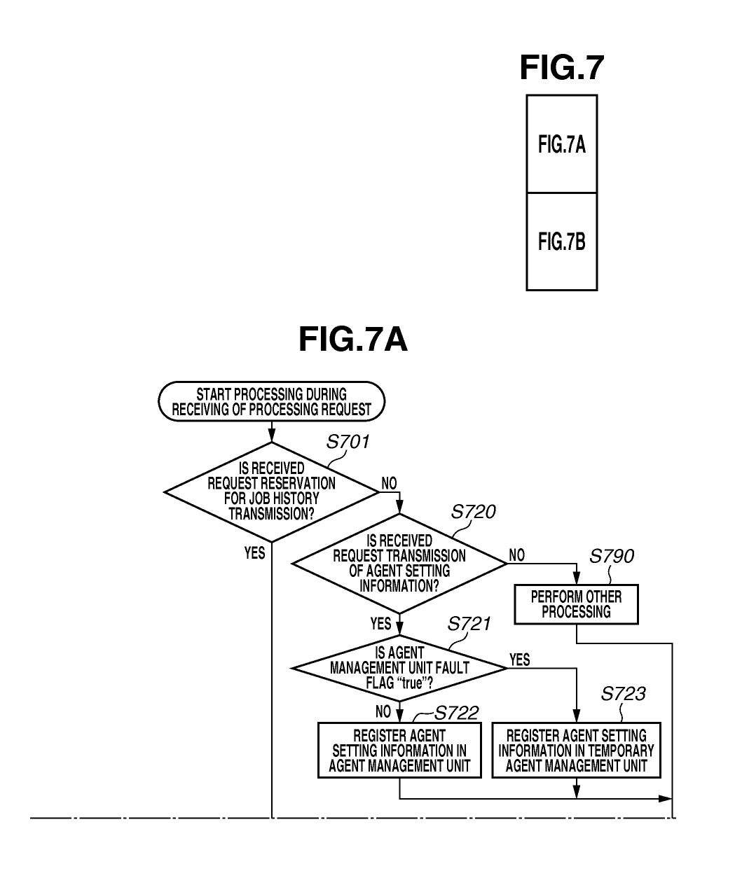

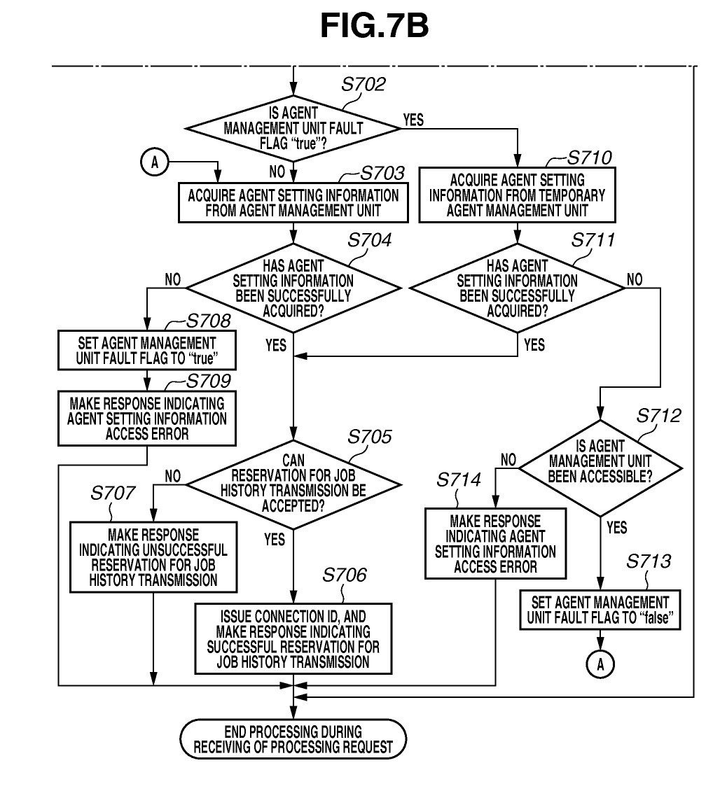

An operation performed when the request processing unit 501 in the job history processing server 101 has received the processing request from the collection agent 404 in the MFP 111 will be described below with reference to FIG. 7.

FIG. 7 is a flowchart illustrating an operation performed when the request processing unit 501 in the job history processing server 101 has received the processing request from the collection agent 404 in the MFP 111 in the first exemplary embodiment. Each of steps illustrated in the flowchart of FIG. 7 is implemented when the CPU 311 in the job history processing server 101 executes a program for implementing the request processing unit 501 stored in the ROM 312 or the HDD 314. The CPU 311 uses the RAM 313 or the HDD 314 as a storage area, as needed.

The request processing unit 501 starts the processing in the flowchart when it receives a request from the collection agent 404. In step S701, the request processing unit 501 first determines whether the request received from the collection agent 404 is a reservation for job history transmission. If the request processing unit 501 determines that the received request is the reservation for job history transmission (YES in step S701), the processing proceeds to step S702.

In step S702, the request processing unit 501 determines whether an agent management unit fault flag is “true”. The agent management unit fault flag is a flag indicating whether a fault has occurred in the agent management unit 505. A case where the agent management unit fault flag is “true” means that the agent management unit 505 is unusable. For example, the agent management unit 505 becomes unusable when the agent management server 102 has been down. In the present exemplary embodiment, the agent management unit fault flag is stored in a file on the HDD 314 in the job history processing server 101.

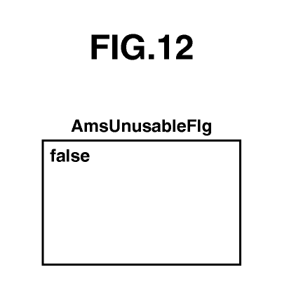

FIG. 12 illustrates the file storing the agent management unit fault flag.

As illustrated in FIG. 12, in the present exemplary embodiment, a file name of the agent management unit fault flag is “AmsUnusableFlg”, and its content is a character string “true” or “false”.

The flowchart of FIG. 7 will be described below again. If the request processing unit 501 determines that the agent management unit fault flag is “false” (NO in step S702), the processing proceeds to step S703. In step 703, the request processing unit 501 acquires agent setting information from the agent management unit 505 using an agent ID included in the request to reserve the job history transmission as a key.

In step S704, the request processing unit 501 then determines whether the agent setting information has been successfully acquired in step S703. If the request processing unit 501 determines that the agent setting information has been successfully acquired (YES in step S704), the processing proceeds to step S705.

In step S705, the request processing unit 501 determines whether the requested reservation for the job history transmission can be accepted. The determination of whether the requested reservation for the job history transmission can be accepted is performed depending on whether the number of reservations that are being accepted does not reach the maximum number of reservations previously set in the job history processing server 101, for example. The number of reservations that are being accepted is stored in the HDD 314 in the job history processing server 101.

If the request processing unit 501 determines that the job history transmission reservation can be accepted (YES in step S705), the request processing unit 501 increases the number of reservations that are being accepted, by one, and the processing proceeds to step S706.

In step S706, the request processing unit 501 issues a connection ID for identifying a connection for job history transmission, associates the issued connection ID with the acquired agent setting information, and stores the connection ID in an area storing the received job history (a job history receiving area) on the HDD 314.

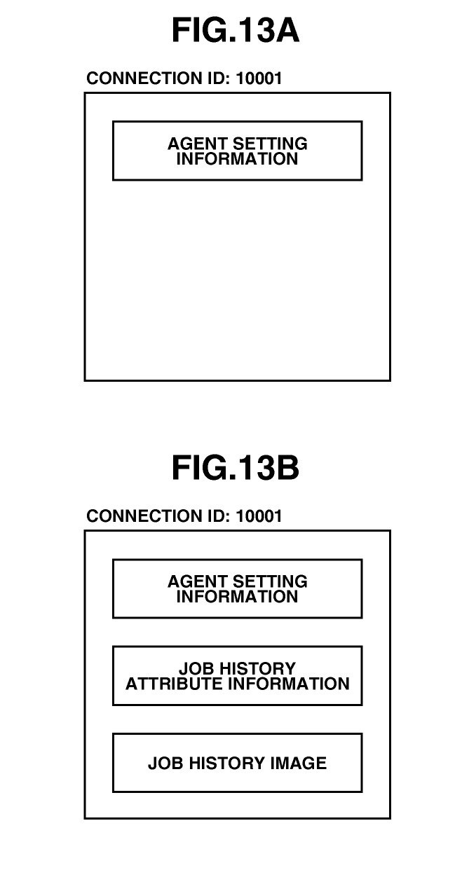

FIG. 13A illustrates data stored in the job history receiving area when the job history transmission is reserved. In the present exemplary embodiment, the request processing unit 501 generates a folder for each issued connection ID in the job history receiving area, and stores the agent setting information to be associated in the holder. The request processing unit 501 makes a response indicating that the job history transmission has been successfully reserved, including the issued connection ID, to the collection agent 404, and the processing ends.

On the other hand, if the request processing unit 501 determines that the reservation for the job history transmission cannot be accepted (NO in step S705), the processing proceeds to step S707. In step S707, the request processing unit 501 makes a response indicating that the job history transmission has been unsuccessfully reserved to the collection agent 404, and the processing ends.

If the request processing unit 501 determines that the agent setting information has been unsuccessfully acquired because the database in the agent management unit 505 has been down (NO in step S704), the processing proceeds to step S708.

In step S708, the request processing unit 501 sets the agent management unit fault flag to “true”. In step S709, the request processing unit 501 then makes a response indicating an agent setting information access error to the collection agent 404, and the processing ends. If the agent setting information access error occurs, the agent setting information is transmitted from the collection agent 404, as illustrated in step S609 in FIG. 6, and is registered in the temporary agent management unit 503 in step S723, to be described below.

If the request processing unit 501 determines that the agent management unit fault flag is “true” (YES in step S702), the processing proceeds to step S710. In step S710, the request processing unit 501 acquires the agent setting information from the temporary agent management unit 503 using the agent ID included in the request to reserve the job history transmission as a key.

In step S711, the request processing unit 501 then determines whether the agent setting information has been successfully acquired in step S710. If the request processing unit 501 determines that the agent setting information has been successfully acquired (YES in step S711), the processing proceeds to step S705.

On the other hand, if the request processing unit 501 determines that the agent setting information has been unsuccessfully acquired (NO in step S711), the processing proceeds to step S712. In step S712, the request processing unit 501 accesses the agent management unit 505, and determines whether the agent management unit 505 is accessible. If the request processing unit 501 determines that the agent management unit 505 is accessible (YES in step S712), the processing proceeds to step S713.

In step S713, the request processing unit 501 determines that a fault in the agent management unit 505 has been restored, and sets the agent management unit fault flag to “false”. The processing proceeds to step S703.

On the other hand, if the request processing unit 501 determines that the agent management unit 505 is not accessible (NO in step S712), the processing proceeds to step S714. In step S714, the request processing unit 501 makes a response indicating the agent setting information access error to the collection agent 404, like in step S709, described above, and the processing ends.

If the request processing unit 501 determines that the received request is not the reservation for the job history transmission (NO in step S701), the processing proceeds to step S720. In step S720, the request processing unit 501 determines whether the request received from the collection agent 404 is transmission of the agent setting information.

If the request processing unit 501 determines that the received request is the transmission of the agent setting information (YES in step S720), the processing proceeds to step S721. In step S721, the request processing unit 501 determines whether the agent management unit fault flag is “true”. If the request processing unit 501 determines that the agent management unit fault flag is “false” (NO in step S721), the processing proceeds to step S722.

In step S722, the request processing unit 501 registers the received agent setting information in the agent management unit 505. The request processing unit 501 issues an agent ID for identifying an agent, to the received agent setting information. The request processing unit 501 registers the received agent setting information, including the issued agent ID, in the agent management unit 505. After the agent setting information is registered, the request processing unit 501 makes a response indicating the issued agent ID to the collection agent 404, and the processing ends.

On the other hand, if the request processing unit 501 determines that the agent management unit fault flag is “true” (YES in step S721), the processing proceeds to step S723.

In step S723, the request processing unit 501 registers the received agent setting information in the temporary agent management unit 503, and the processing ends. In the present exemplary embodiment, in the temporary agent management unit 503, the agent setting information is stored in the HDD 314 in the job history processing server 101 as a file for each agent.

If the request processing unit 501 determines that the received request is not the transmission of the agent setting information (NO in step S720), the processing proceeds to step S790.

In step S790, the request processing unit 501 performs processing corresponding to a request content such as the job history transmission that has been received from the collection agent 404. If the request to transmit the job history is received, for example, then in step S790, the request processing unit 501 stores the transmitted job history in the job history receiving area in association with the connection ID included in the request.

FIG. 13B illustrates data stored in the job history receiving area after the job history is stored.

When the receiving of the job history is completed, the request processing unit 501 performs conversion processing for a job history image associated with the same connection ID and processing for adding information required for an audit in the agent setting information to the job history attribute information, in the background. An example of the job history attribute information after the addition processing is performed is illustrated in Table 3. Further, the request processing unit 501 issues a job history ID for uniquely identifying a job history, and transmits agent setting information, a processed job history image, and job history attribute information to the job history audit system 131 in association with the issued job history ID.

TABLE 3

| Attribute Item | Attribute Value |
|---|---|
| Job Type | Printing |
| Execution User Name | User A |
| Execution Date and Time | 2014/05/01 13:15:24 |
| Execution Result | Normal Exit |
| Communication Destination | |
| Agent ID | 0001 |
| Apparatus Name | Development Unit MFP1 |
| Product Model Name | abc100ef |
| Product Serial Number | 1234567890 |
| IP Address | 192.168.1.10 |
| MAC Address | XX-XX-XX-XX-XX-XX |

If the request to release the reservation for the job history transmission has been received, then in step 790, the request processing unit 501 decreases, by one, the above described number of reservations which are being accepted.

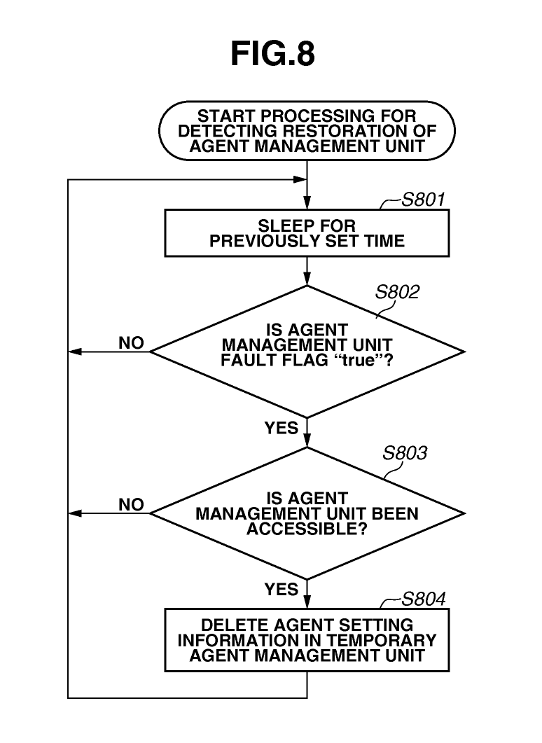

An operation of the server management unit 504 in the job history processing server 101 will be described below with reference to FIG. 8. FIG. 8 is a flowchart illustrating an operation of the server management unit 504 in the job history processing server 101. Each of steps illustrated in the flowchart of FIG. 8 is implemented when the CPU 311 in the job history processing server 101 executes a program for implementing the server management unit 504 stored in the ROM 312 or the HDD 314. The CPU 311 uses the RAM 313 or the HDD 314 as a storage area, as needed. Processing illustrated in the flowchart of FIG. 8 is always being performed while the job history processing server 101 is being started.

In step S801, the server management unit 504 sleeps for a previously set time, e.g., 10 seconds. In step S802, the server management unit 504 then determines whether the agent management unit fault flag is “true”. If the server management unit 504 determines that the agent management unit fault flag is “false” (NO in step S802), the processing returns to step S801.

On the other hand, if the server management unit 504 determines that the agent management unit fault flag is “true” (YES in step S802), the processing proceeds to step S803. In step S803, the server management unit 504 accesses the agent management unit 505, and confirms whether the agent management unit 505 is accessible. If the server management unit 504 determines that the agent management unit 505 is not accessible (NO in step S803), the processing returns to step S801.

On the other hand, if the server management unit 504 determines that the agent management unit 505 is accessible (YES in step S803), the processing proceeds to step S804. In step S804, the server management unit 504 deletes the agent setting information registered in the temporary agent management unit 503. The server management unit 504 deletes the agent setting information, and thereafter, the processing returns to step S801.

As described above, in the first exemplary embodiment, if the agent management unit 505 becomes inaccessible, the request processing unit 501 makes a response “agent setting information access error” to the collection agent 404 (step S709 in FIG. 7). The collection agent 404, which has received the response “agent setting information access error”, transmits the agent setting information owned by itself to the job history processing server 101 (step S609 in FIG. 6). The request processing unit 501, which has received the agent setting information, registers the agent setting information in the temporary agent management unit 503 (step S723 in FIG. 7), and then operates by referring to the agent setting information (step S710 in FIG. 7). By such processing, the job history processing server 101 can accept a job history even if the agent management unit 505 is inaccessible, and can further add the information required for the audit from the agent setting information to the job history attribute information and export the added information to an area that can be referred to by the external system such as the job history audit system 131.

If the agent management unit 505 becomes accessible, the server management unit 504 deletes the agent setting information registered in the temporary agent management unit 503 (step S804 in FIG. 8). By such processing, the request processing unit 501 unsuccessfully acquires the agent setting information from the temporary agent management unit 503 (step S710 in FIG. 7) (NO in step S711 illustrated in FIG. 7). The request processing unit 501 checks access to the agent management unit 505 and confirms whether the agent management unit 505 has been restored (YES in step S712 in FIG. 7). The request processing unit 501 can return to an operation during a normal time (step S713 in FIG. 7).

As described above, according to the first exemplary embodiment, even if the management service for managing the agent setting information about each of the collection agents 404 (the agent management unit 505 in the agent management service 102) becomes inaccessible because the fault occurs therein, the agent setting information is acquired from the collection agent 404 and is temporarily stored in the temporary agent management unit 503 in the job history processing server 101 so that the continuously received job history can be processed and transferred to the job history audit system 131. Thus, the immediacy of the audit of the job history can be maintained.

As described above, the job history processing server 101 may include the agent management server 102. In such a configuration, even if a fault occurs in a management function (the agent management unit 505) for managing agent setting information about each of the collection units 404, the agent setting information is acquired from the collection agent 404 and is temporarily stored in the temporary agent management unit 503 so that a continuously received job history can be processed and transferred to the job history audit system 131. Thus, the immediacy of an audit of the job history can be maintained.

A second exemplary embodiment will be described below. In the second exemplary embodiment, an example in which the number of MFPs is large, to cope with a large-scale environment in which in a case where a single job history processing server is used, it is impossible to process job histories transmitted from an MFP will be mainly described. Description of a portion overlapping that in the first exemplary embodiment is not repeated, and only a difference therebetween will be described.

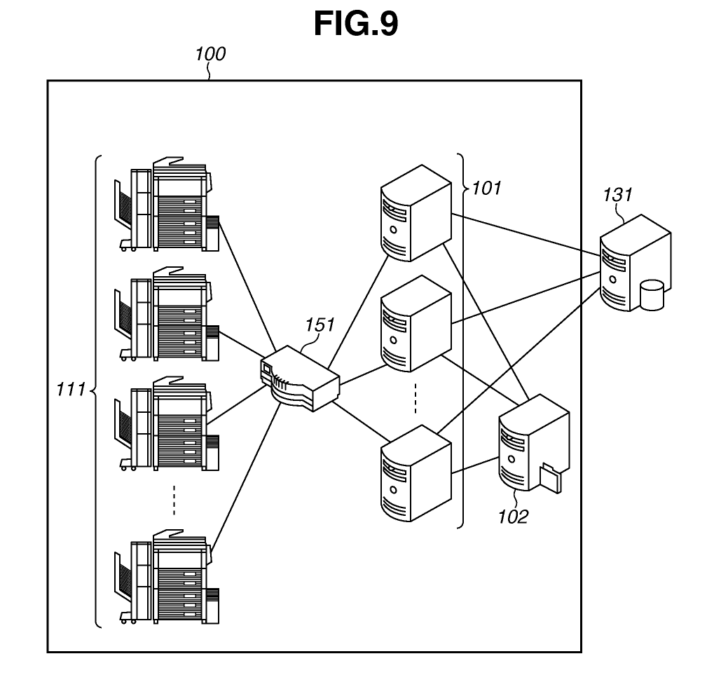

FIG. 9 illustrates a configuration of a job history processing system 100 according to the second exemplary embodiment of the present invention and a job history audit system 131 associated therewith.

In a job history processing system 100 in the present exemplary embodiment, a plurality of MFPs 111 and a plurality of job history processing servers 101 are connected to each other via a load balancer (a load distribution device) 151. The job history processing servers 101 in the second exemplary embodiment accept data to be collected via the load balancer 151 from a collection agent 404. An agent management server 102 in the present exemplary embodiment is common to the plurality of job history processing servers 101 when used. An agent management unit 505 in the agent management server 102 provides a function for managing agent setting information in an integrated manner for the plurality of job history processing servers 101. While the agent management unit 505 is implemented by a database in the present exemplary embodiment, like in the first exemplary embodiment, the present invention is not limited to this. The agent management unit 505 may be implemented by a file server.

The load balancer 151 is a general load distribution device, and assigns connections with the job history processing servers 101 from the MFP 111 so that a load is distributed among the plurality of job history processing servers 101. More specifically, the load balancer 151 distributes a data transfer destination from the collection agent 404 among the plurality of job history processing servers 101. The load balancer 151 also has a function of interpreting server designation information included in a request transmitted from the collection agent 404 and transmitting a request to the designated job history processing server 101.

In the present exemplary embodiment, the load balancer 151 issues server designation information when it makes a response to a request from the collection agent 404 by the job history processing server 101, to the collection agent 404, and includes the issued server designation information in the response. However, the present invention is not limited to this. The job history processing server 101 may issue server designation information when it makes a response to the request from the collection agent 404 and include the issued server designation information in the response. The server designation information includes information for identifying a transmission destination of the request from the collection agent 404.

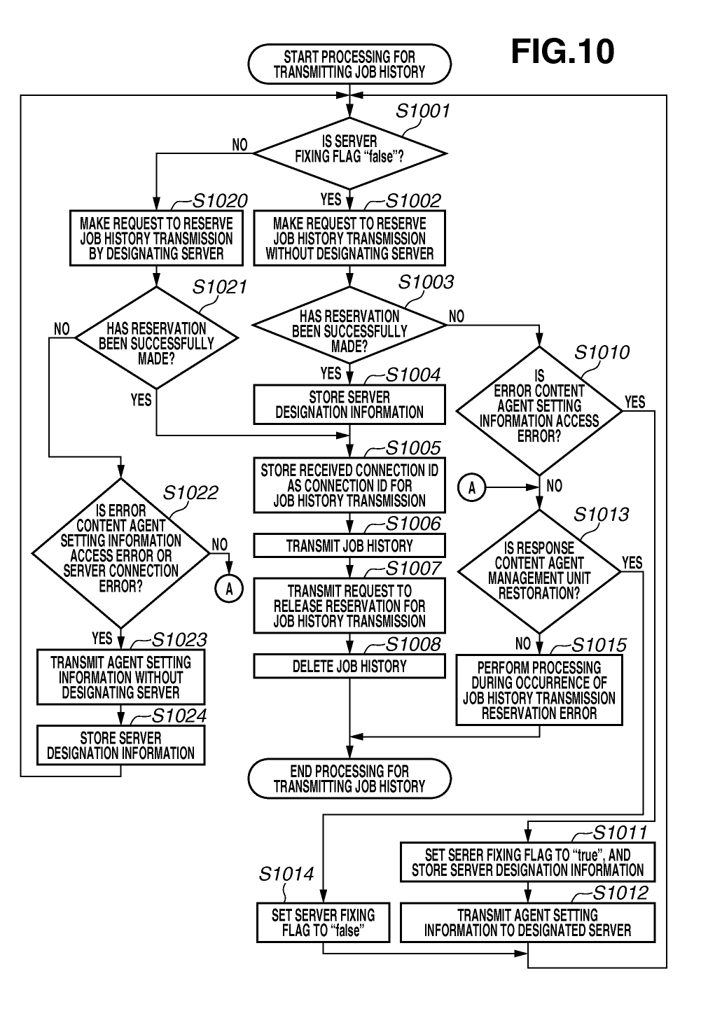

An operation performed when the collection agent 404 in the MFP 111 transmits the job history to the job history processing server 101 in the second exemplary embodiment will be described below with reference to FIG. 10.

FIG. 10 is a flowchart illustrating an operation performed when the collection agent 404 in the MFP 111 transmits the job history to the job history processing server 101 in the second exemplary embodiment. Each of steps illustrated in the flowchart of FIG. 10 is implemented when a CPU 201 in the MFP 111 executes a program for implementing the collection agent 404 stored in a ROM 203 or a HDD 204. The CPU 201 uses a RAM 202 or the HDD 204 as a storage area, as needed.

In step S1001, the collection agent 404 determines whether a server fixing flag stored by itself is “false”. The server fixing flag is used to determine whether a server of a destination of a request to reserve job history transmission is fixed to a specific server, and becomes “true” if the agent management server 102 cannot be used. In the present exemplary embodiment, the server fixing flag is stored in a file on a HDD 314.

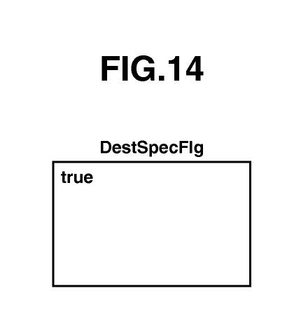

FIG. 14 illustrates the file storing the server fixing flag. In the present exemplary embodiment, a name of the file storing the server fixing flag is “DestSpecFlg”, and its content is a character string “true” or “false”.

The flowchart of FIG. 10 will be described below again. If the collection agent 404 determines that the server fixing flag is “false” (YES in step S1001), the processing proceeds to step S1002 as processing during a normal time.

In step S1002, the collection agent 404 makes a request to reserve the job history transmission, like in step S601 illustrated in FIG. 6.

In step S1003, the collection agent 404 then receives a response to the reservation for the job history transmission, confirms its content, and determines whether the reservation has been successfully made, like in step S602 illustrated in FIG. 6. If the collection agent 404 determines that the reservation has been successfully made (YES in step S1003), the processing proceeds to step S1104.

In step S1004, the collection agent 404 stores server designation information included in the response which has been received in step S1003, in the HDD 204, for example. As described above, in the present exemplary embodiment, the server designation information is issued by the load balancer 151, and is included in the response. If the server designation information has already been stored during the execution in step S1004, the collection agent 404 rejects the already stored server designation information, and newly stores the server designation information included in the response again.

In step S1005, the collection agent 404 then temporarily stores a connection ID included in the response which has been received in step S1003, as a connection ID for job history transmission, like in step S603 illustrated in FIG. 6.

In step S1006, the collection agent 404 then transmits the job history, including the server designation information which has been stored in step S1005, in addition to the connection ID for job history transmission. The collection agent 404 can transmit the job history to the job history processing server 101 which has reserved the job history transmission, even via the load balancer 151 by including the server designation information in the job history transmission.

In step S1007, the collection agent 404 then transmits a request to release the reservation for the job history transmission. In step S1007, the collection agent 404 also transmits a request, including the stored server designation information, in addition to the connection ID for job history transmission, like in step S1006.

In step S1008, the collection agent 404 then deletes the job history which has been transmitted, from the HDD 204, like in step S606 illustrated in FIG. 6, and the processing ends.

If the collection agent 404 determines that the reservation has been unsuccessfully made (NO in step S1003), the processing proceeds to step S1010. In step S1010, the collection agent 404 determines whether an error content indicating that the job history transmission has been unsuccessfully reserved is an agent setting information access error, like in step S607 illustrated in FIG. 6.

If the collection agent 404 determines that the error content indicating that the job history transmission has been unsuccessfully reserved is not the agent setting information access error (NO in step S1010), the processing proceeds to step S1013. In step S1013, the collection agent 404 determines whether a content of a response to the reservation for the job history transmission is restoration of the agent management unit 505.

If the collection agent 404 determines that the content of the response is the restoration of the agent management unit 505 (YES in step S1013), the processing proceeds to step S1014. In step S1014, the collection agent 404 sets a server fixing flag stored by itself to “false”, and the processing returns to step S1001. Thus, the collection agent 404 makes the subsequent reservation for the job history transmission for the job history processing servers 101 to which connections have been assigned by the load distribution device, without designating the job history processing server 101.

On the other hand, if the collection agent 404 determines that the content of the response to the reservation for the job history transmission is not the restoration of the agent management unit 505 (NO in step S1013), the processing proceeds to step S1015. In step S1015, the collection agent 404 performs processing during occurrence of a job history transmission reservation error, like in step S608 illustrated in FIG. 6, and the processing ends.

If the collection agent 404 determines that the error content indicating that the job history transmission has been unsuccessfully reserved is the agent setting information access error (YES in step S1010), the processing proceeds to step S1011.

In step S1011, the collection agent 404 sets the server fixing flag stored by itself to “true” while storing the server designation information included in the response to the reservation for the job history transmission, in the HDD 204, for example. If the server designation information has already been stored during the execution in step S1011, the collection agent 404 rejects the already stored server designation information, and newly stores the server designation information included in the response again.

In step S1012, the collection agent 404 then transmits the agent setting information owned by itself, including the server designation information stored in step S1011, to the request processing unit 501 in the job history processing server 101, and the processing returns to step S1001. By processes in steps S1011 and 1012, the collection agent 404 can transmit agent setting information owned by itself to the job history processing server 101 that has returned the agent setting information access error. Further, the collection agent 404 can transmit the job history to the job history processing server 101 that has transmitted the agent setting information owned by itself. More specifically, after the agent information that has been transmitted in step S1012 is stored in the job history processing server 101, an address for data transfer is fixed to the job history processing sever 101 serving as a transmission destination of the agent information.

If the collection agent 404 determines that the server fixing flag is “true” (NO in step S1001), the processing proceeds to step S1020 as processing at an abnormal time.

In step S1020, the collection agent 404 makes a request to reserve the job history transmission, including the stored server designation information. The server designation information to be used is stored when the server fixing flag is set to “true”, and is used to designate the job history processing server 101 to which the agent setting information owned by itself has been transmitted. The collection agent 404 can transmit the job history to the job history processing server 101 to which the agent setting information owned by itself has been transmitted when it has received the agent setting information access error, by using the server designation information.

In step S1021, the collection agent 404 then receives a response to the reservation for the job history transmission, and determines its content, like in step S1003.

If the collection agent 404 determines that the reservation has been successfully made (YES in step S1021), the processing proceeds to step S1005.

On the other hand, if the collection agent 404 determines that the reservation has been unsuccessfully made (NO in step S1021), the processing proceeds to step S1022. In step S1022, the collection agent 404 determines whether an error content indicating that the job history transmission has been unsuccessfully reserved is an agent setting information access error or a server connection error.

If the collection agent 404 determines that the error content is neither the agent setting information access error nor the server connection error (NO in step S1022), the processing proceeds to step S1013.

On the other hand, if the collection agent 404 determines that the error content indicating that the job history transmission has been unsuccessfully reserved is either the agent setting information access error or the server connection error (YES in step S1022), the processing proceeds to step S1023.

In step S1023, the collection agent 404 transmits the agent setting information owned by itself which does not include the server designation information. Thus, the collection agent 404 can transmit the agent setting information to the job history processing server 101 other than the job history processing server 101 in which a fault has occurred.

In step S1024, the collection agent 404 then receives and stores the server designation information included in the response to the transmission of the agent setting information in step S1023, and the processing returns to step S1001.

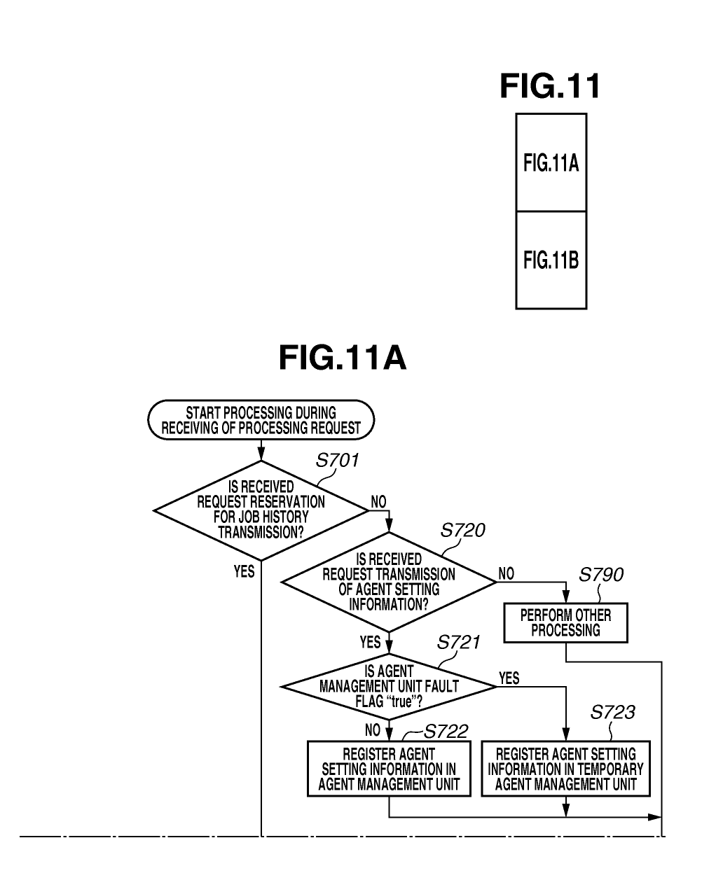

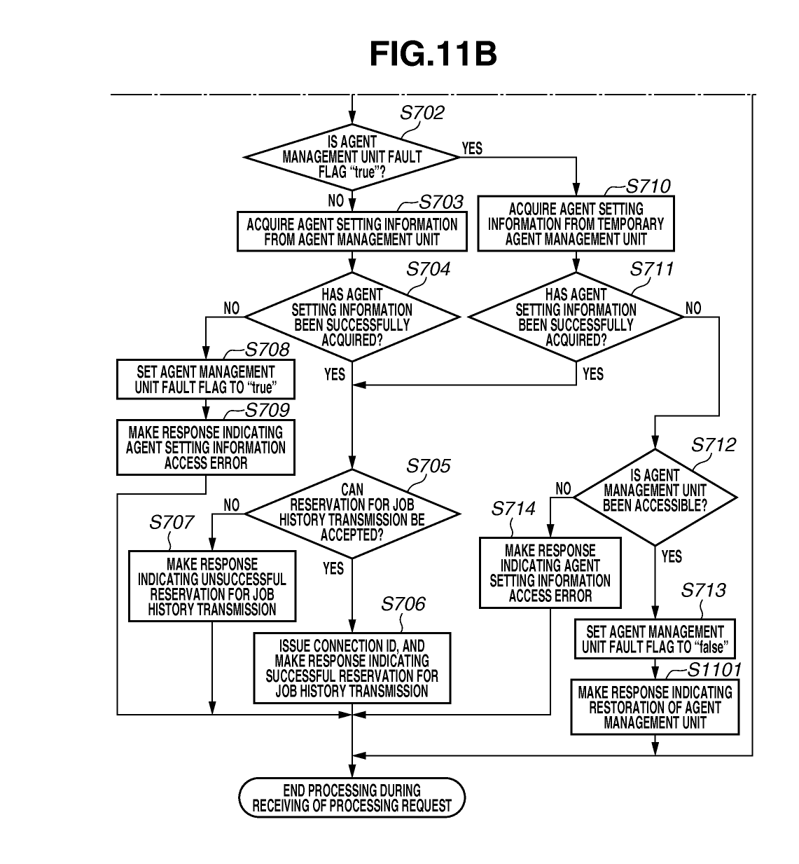

An operation performed when the request processing unit 501 in the job history processing server 101 has received the processing request from the collection agent 404 in the MFP 111 in the second exemplary embodiment will be described below with reference to FIG. 11. FIG. 11 is a flowchart illustrating an operation performed when the request processing unit 501 in the job history processing server 101 has received the processing request from the collection agent 404 in the MFP 111 in the second exemplary embodiment. Each of steps illustrated in the flowchart of FIG. 11 is implemented when a CPU 311 in the job history processing server 101 executes a program for implementing the request processing unit 501 stored in the ROM 312 or the HDD 314. The CPU 311 uses a RAM 313 or the HDD 314 as a storage area, as needed. FIG. 11 differs from FIG. 7 only in that step S1101 is performed subsequently to step S713 illustrated in FIG. 7. Therefore, steps similar to those illustrated in FIG. 7 are assigned the same reference numerals as those illustrated in FIG. 7, and description thereof is not repeated. Only step S1101 will be described.

When the request processing unit 501 ends the process in step S713, the processing proceeds to step S1011. In step S1101, the request processing unit 501 makes a response indicating that the agent management unit 505 has been restored, to the collection agent 404, and the processing ends. When the collection agent 404 receives the response in step S1101, the collection agent 404 determines that the content of the response is the restoration of the agent management unit 505 in step S1013 illustrated in FIG. 10, and sets the server fixing flag to “false” in step S1014. Thus, the collection agent 404 can return to an operation at a normal time. An operation of the server management unit 504 is similar to that in the first exemplary embodiment, and hence description thereof is not repeated.

In the second exemplary embodiment, the collection agent 404 stores the server designation information in step S1011 illustrated in FIG. 10 and transmits the agent setting information to the job history processing server 101 designated thereby. However, the collection agent 404 need not store the server designation information in step S1011 illustrated in FIG. 10. In such a configuration, the collection agent 404 transmits the agent setting information which does not include the server designation information, in step S1012 illustrated in FIG. 10, and stores server designation information included in a response thereto.

As described above, according to the second exemplary embodiment, when a load is distributed among the plurality of job history processing servers 101, even if a management service for managing agent setting information about each of the collection agents 404 (the agent management unit 505 in the agent management server 102) becomes inaccessible because a fault occurs therein, agent setting information is acquired from each of the collection agents 404 and is temporarily stored in the temporary agent management unit 503 in each of the job history processing servers 101 so that a continuously received job history can be processed and transferred to the job history audit system 131. Thus, the immediacy of an audit of the job history can be maintained.

A third exemplary embodiment will be described below. In the above described second exemplary embodiment, when the agent management unit 505 cannot be used, if one of the job history processing servers 101 has been down, then in the collection agent 404 which takes the down job history processing server 101 as a job history transmission destination, the job history transmission destination is changed to another job history processing server 101. After such a state occurs once, if the down job history processing server 101 has been restored, the restored job history processing server 101 is not accessed from the collection agent 404. Therefore, the restored job history processing server 101 becomes useless. In addition to that, a load of another job history processing server 101 does not decrease, and job history processing is delayed, which may cause interference with system operation. A third exemplary embodiment copes with such a problem. In the present exemplary embodiment, description of a portion overlapping that in the second exemplary embodiment is not repeated, and only a difference therebetween will be described.

In the present exemplary embodiment, a server management unit 504 in each of the job history processing servers 101 has a list of address information about the job history processing servers 101 in a job history processing system 100 (a job history processing server list). An agent management unit 505 may store the job history processing server list to be a master, and each of the job history processing servers 101 may acquire and store the stored job history processing server list as a job history processing server list. Alternatively, a system administrator may manually generate the job history processing server list on any one of the job history processing servers 101 and manually distribute the generated job history processing server list to the job history processing servers 101.

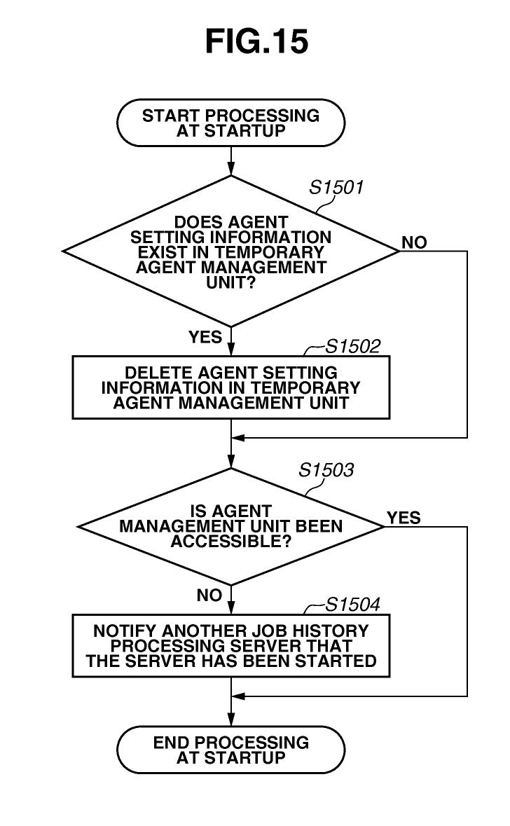

An operation of the server management unit 504 when the job history processing server 101 has been started (at startup) in the third exemplary embodiment will be described below with reference to FIG. 15. FIG. 15 is a flowchart illustrating processing for issuing a notification that the job history processing server 101 has been started in the third exemplary embodiment. Each of steps illustrated in the flowchart of FIG. 15 is implemented when a CPU 311 in the job history processing server 101 executes a program for implementing the server management unit 504 stored in a ROM 312 or a HDD 314. The CPU 311 uses a RAM 313 or the HDD 314 as a storage area, as needed.

In step S1501, the server management unit 504 determines whether agent setting information exists in a temporary agent management unit 503. If the server management unit 504 determines that agent setting information exists in the temporary agent management unit 503 (YES in step S1501), the processing proceeds to step S1502.

In step S1502, the server management unit 504 deletes the entire agent setting information in the temporary agent management unit 503, and the processing proceeds to step S1503. On the other hand, if the server management unit 504 determines that the agent setting information does not exist in the temporary agent management unit 503 (NO in step S1501), the processing proceeds to step S1503.

In step S1503, the server management unit 504 accesses an agent management unit 505, and determines whether the agent management unit 505 is accessible. If the server management unit 504 determines that the agent management unit 505 is accessible (YES in step S1503), the processing ends.

On the other hand, if the server management unit 504 determines that the agent management unit 505 is inaccessible (NO in step S1503), the processing proceeds to step S1504.

In step S1504, the server management unit 504 notifies the server management unit 504 in another job history processing server 101 that the job history processing server 101 has been started using a job history processing server list (transmits a start notification). Then, the processing ends.

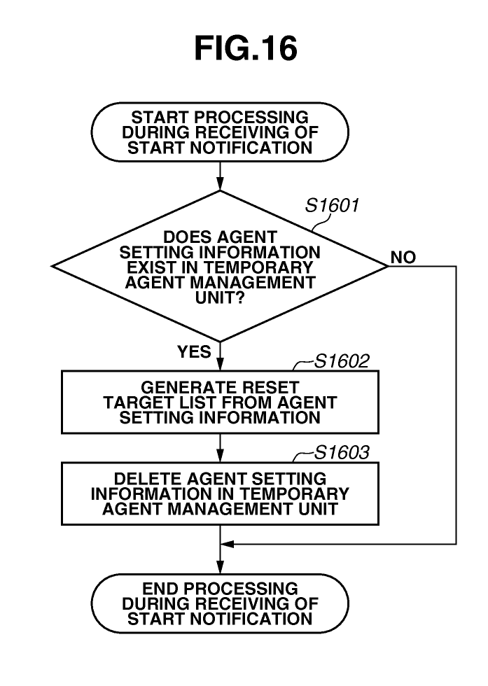

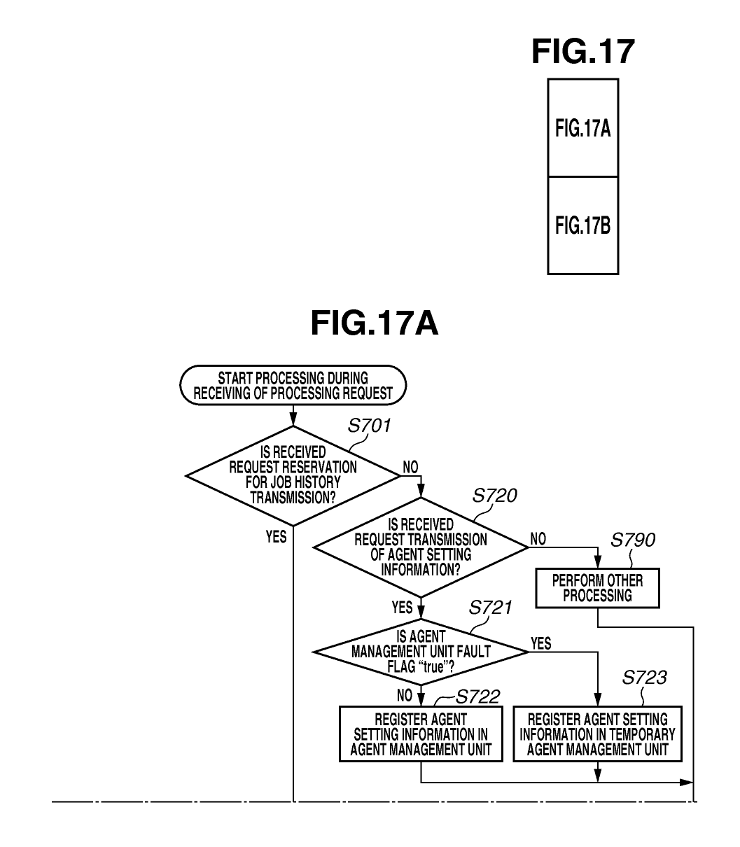

An operation of the sever management unit 504 that has accepted the notification (start notification) in step S1504 illustrated in FIG. 15 will be described below with reference to FIG. 16. FIG. 16 is a flowchart illustrating processing for receiving the start notification of the job history processing server 101 in the third exemplary embodiment. Each of steps illustrated in the flowchart of FIG. 16 is implemented when the CPU 311 in the job history processing server 101 executes a program for implementing the server management unit 504 stored in the ROM 312 or the HDD 314. The CPU 311 uses the RAM 313 or the HDD 314 as a storage area, as needed.

The server management unit 504 starts the processing in the flowchart when it has received the start notification from another job history processing server 101. In step S1601, the server management unit 504 determines whether agent setting information exists in the temporary agent management unit 503. If the server management unit 504 determines that the agent setting information does not exist (NO in step S1601), the processing ends.

On the other hand, if the server management unit 504 determines that the agent setting information exists (YES in step S1601), the processing proceeds to step S1602. In step S1602, the server management unit 504 generates a list of agents that reset server designation information (a reset target list) stored in the collection agent 404 from the agent setting information in the temporary agent management unit 503. The reset target list specifically includes agent IDs of the agent setting information in the temporary agent management unit 503.

In step S1603, the server management unit 504 then deletes the entire agent setting information in the temporary agent management unit 503, and the processing ends.

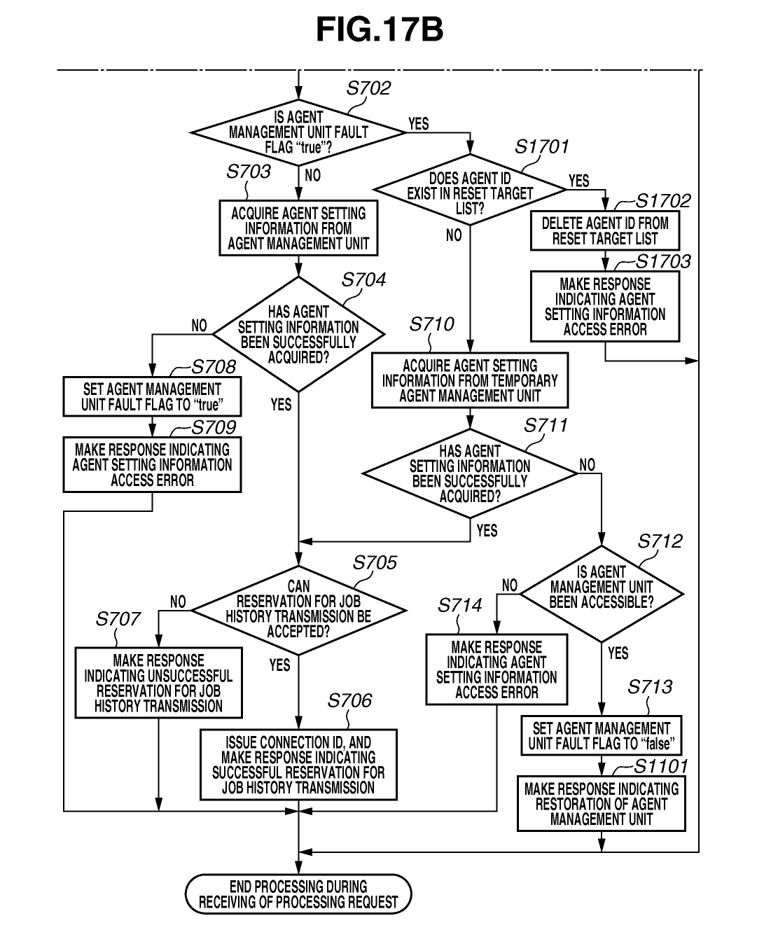

An operation performed when a request processing unit 501 in the job history processing server 101 has received a processing request from the collection agent 404 in the MFP 111 in the third exemplary embodiment will be described below with reference to a flowchart of FIG. 17. FIG. 17 is a flowchart illustrating an operation performed when the request processing unit 501 in the job history processing server 101 has received a processing request from the collection agent 404 in the MFP 111 in the third exemplary embodiment. Each of steps illustrated in the flowchart of FIG. 17 is implemented when the CPU 311 in the job history processing server 101 executes a program for implementing the request processing unit 501, which is stored in the ROM 312 or the HDD 314. The CPU 311 uses the RAM 313 or the HDD 314 as a storage area, as needed. The processing illustrated in FIG. 17 differs from the processing illustrated in FIG. 11 in that steps S1701 to S1703 are added. Therefore, steps similar to those illustrated in FIG. 11 are assigned the same reference numerals as those illustrated in FIG. 11, and hence description thereof is not repeated. Only steps S1701 to S1703 will be described.

If the request processing unit 501 according to the third exemplary embodiment determines that an agent management unit fault flag is “true” (YES in step S702), the processing proceeds to step S1701. In step S1701, the request processing unit 501 determines whether an agent ID of the collection agent 404 serving as a transmission source of a reservation for job history transmission exists in the reset target list that has been generated in step S1602 illustrated in FIG. 16.

If the request processing unit 501 determines that the agent ID does not exist in the reset target list (NO in step S1701), the processing proceeds to step S710. On the other hand, if the request processing unit 501 determines that the agent ID exists in the reset target list (YES in step S1701), the processing proceeds to step S1702.

In step S1702, the request processing unit 501 deletes the agent ID of the collection agent 404 serving as the transmission source of the reservation for the job history transmission from the reset target list.

In step S1703, the request processing unit 501 makes a response indicating an agent setting information access error to the collection agent 404 serving as the transmission source of the reservation for the job history transmission, and the processing ends.

As described above, according to the third exemplary embodiment, when the agent management unit 505 cannot be used, if any one of the job history processing servers 101 has been down and has been started again, server designation information about the collection agent 404 can be reset. Thus, an offset of the job history processing server 101, which is requested by the collection agent 404, can be resolved, and the restored job history processing server 101 can be effectively utilized.

In the third exemplary embodiment, not the server management unit 504 but the request processing unit 501 or the temporary agent management unit 503 may perform processing performed when the job history processing server 101 is started (processing illustrated in FIG. 15). The same applies to processing illustrated in FIG. 16.

In the third exemplary embodiment, in step S1702 illustrated in FIG. 17, the request processing unit 501 deletes the agent ID of the collection agent 404, to which the response indicating the agent setting information access error is made, from the reset target list. However, in step S1702, the agent ID of the collection agent 404 in the reset target list is not actually deleted only by marking “deleted” but may be deleted after a lapse of a predetermined period of time. In such a configuration, if the same collection agent 404 has transmitted the reservation for the job history transmission again because the collection agent 404 does not normally receive the agent setting information access error in step S1703, the request processing unit 501 can detect the transmitted reservation for the job history transmission in step S1701. Thus, the request processing unit 501 can make a response indicating the agent setting information access error to the collection agent 404 serving as the transmission source again by omitting processes in steps S710, S711, and S712.

A fourth exemplary embodiment will be described below. In the fourth exemplary embodiment, an example in which the number of collection agents 404 listed in the reset target list in the third exemplary embodiment is reduced will be described. In the present exemplary embodiment, description of a portion overlapping that in the third exemplary embodiment is not repeated, and only a difference therebetween will be described.

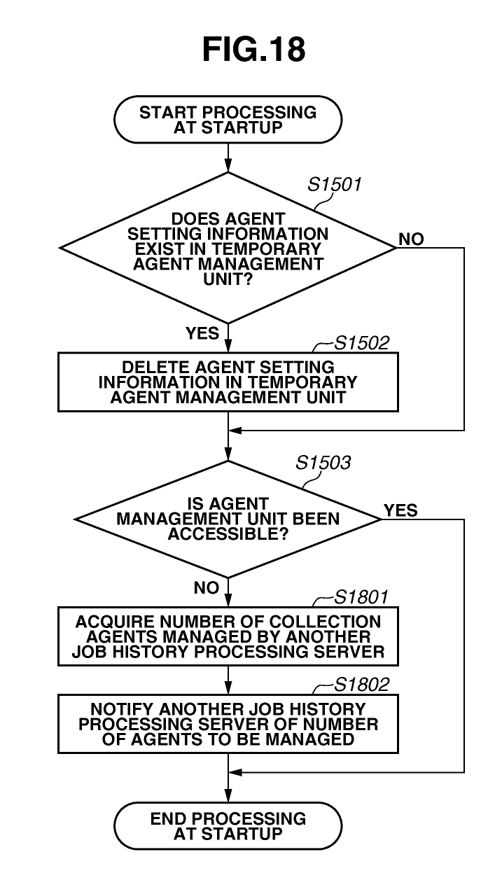

An operation of a server management unit 504 when a job history processing server 101 has been started (at startup) in the fourth exemplary embodiment will be described with reference to FIG. 18.

FIG. 18 is a flowchart illustrating processing for receiving a notification that the job history processing server 101 has been started in the fourth exemplary embodiment. Each of steps illustrated in the flowchart of FIG. 18 is implemented when a CPU 311 in the job history processing server 101 executes a program for implementing a server management unit 504 stored in a ROM 312 or a HDD 314. The CPU 311 uses a RAM 313 or the HDD 314 as a storage area, as needed. Processing illustrated in FIG. 18 differs from the processing illustrated in FIG. 15 in that steps S1801 and S1802 are added instead of step S1504. Therefore, steps similar to those illustrated in FIG. 15 are assigned the same reference numerals as those illustrated in FIG. 15, and hence description thereof is not repeated. Only steps S1801 and S1802 will be described.

If the server management unit 504 in the fourth exemplary embodiment determines that an agent management unit 505 is inaccessible (NO in step S1503), the processing proceeds to step S1801. In step S1801, the server management unit 504 inquires of the server management unit 504 in another job history processing server 101 the number of collection agents 404 that is being managed by using a job history processing server list to acquire the number of collection agents 404.

In step S1802, the server management unit 504 sums the numbers of collection agents 404, which have been acquired from the job history processing servers 101 in step S1801, and divides the obtained total number of the collection agents 404 by the number of the job history processing servers 101. Thus, the number of collection agents 404 to be managed by one of the job history processing servers 101 (the number of collection agents 404 per one of the job history processing servers 101) is calculated. The server management unit 504 notifies the server management unit 504 in each of the job history processing servers 101 of the calculated number of collection agents 404 per one of the job history processing servers 101 (transmits a notification of the number of collection agents 404), and the processing ends.

More specifically, the server management unit 504 in the job history processing server 101 acquires stored agent setting information (i.e., the number of collection agents 404 that is being managed), when the job history processing server 101 is started, from another job history processing server 101, calculates agent setting information that may be stored in each of the job history processing servers 101 serving as an acquisition source (i.e., the number of collection agents 404 that may be managed) based on the acquired total number of collection agents 404, and notifies each of the job history processing servers 101 of the calculated agent setting information (number of collection agents 404).

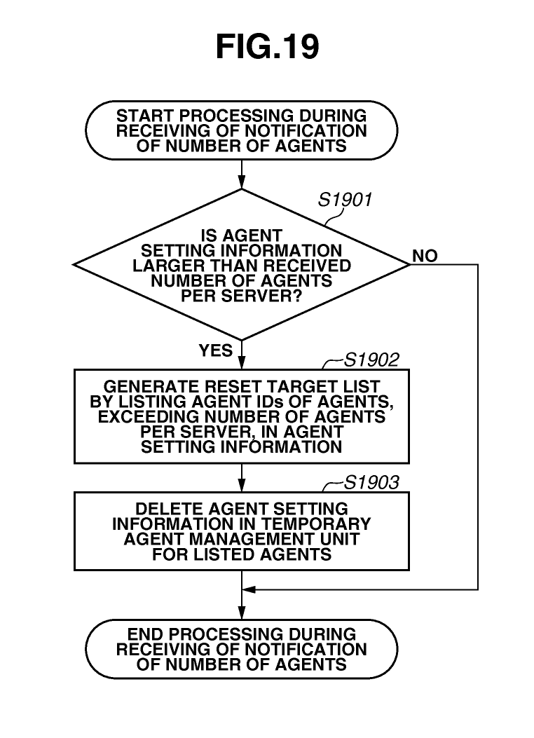

An operation of the server management unit 504, which has received the notification of the number of collection agents 404 per one of the job history processing servers 101 in step S1802 illustrated in FIG. 18, will be described below with reference to FIG. 19.

FIG. 19 is a flowchart illustrating processing for receiving a notification of the number of collection agents 404 per one of the job history processing servers 101 in the fourth exemplary embodiment. Each of steps illustrated in the flowchart of FIG. 19 is implemented when the CPU 311 in the job history processing server 101 executes a program for implementing the server management unit 504 stored in the ROM 312 or the HDD 314. The CPU 311 uses the RAM 313 or the HDD 314 as a storage area, as needed.

When the server management unit 504 receives a notification of the number of collection agents 404 from another job history processing server 101, the processing is started. In step S1901, the sever management unit 504 first determines whether agent setting information in the temporary agent management unit 503 is larger than the received number of collection agents 404 per one of the job history processing servers 101. If the server management unit 504 determines that the agent setting information is not larger than the received number of collection agents 404 per one of the job history processing servers 101, i.e., not more than the received number of collection agents 404 per one of the job history processing servers 101 (NO in step S1901), the processing ends.

On the other hand, if the server management unit 504 determines that the agent setting information is larger than the received number of collection agents 404 per one of the job history processing servers 101 (YES in step S1901), the processing proceeds to step S1902.

In step S1902, the server management unit 504 generates a reset target list by listing agent IDs of the collection agents 404, exceeding the number of collection agents 404 per one of the job history processing servers 101, in the agent setting information in the temporary agent management unit 503. The collection agents 404 to be listed may be determined at random, or may be determined in the order from the collection agents 404 to be immediately managed.

In step S1903, the server management unit 504 then deletes the agent setting information in the temporary agent management unit 503 for the collection agents 404, which have been listed in step S1902, and the processing ends.

As described above, according to the fourth exemplary embodiment, the number of collection agents 404 listed in the reset target list in the above described third exemplary embodiment can be reduced. Therefore, the agent setting information need not be registered for all the collection agents 404. Thus, an offset of the job history processing server 101, which is requested by the collection agents 404, can be more efficiently restored than in the third exemplary embodiment.

In the fourth exemplary embodiment, not the server management unit 504 but the request processing unit 501 or the temporary agent management unit 503 may perform processing when the job history processing server 101 is started (processing illustrated in FIG. 18). The same applies to the processing illustrated in FIG. 19.

In the above described exemplary embodiments, a collection source of information to be accepted by the job history processing system 100 is an image forming apparatus such as an MFP and a printing apparatus. However, the collection source of the information to be accepted by the job history processing system 100 is not limited to the image forming apparatus. Any apparatus may be used if it is a network device such as network electric appliances and an information processing apparatus such as a PC.

A configuration in which the collection agent 404 operates on the network device serving as the information collection source such as the MFP 111 has been described. However, a program corresponding to a collection agent 404 may be installed in another network device such as a PC capable of collecting a job history recorded by an apparatus serving as an information collection source, to operate the collection agent 404 on the other network device. In such a configuration, the collection agent 404 which operates on the another network device collects a job history which has been recorded by an apparatus such as an MFP, from the apparatus, and transmits the collected job history to the job history processing server 101. By such a configuration, the job history processing system 100 can manage information about an apparatus that cannot operate the collection agent 404.

In the above described exemplary embodiments, the job history is recorded by the apparatus serving as the information collection source such as the MFP and is transmitted to the job history processing server 101. However, another network device such as a PC, which inputs a jot into the apparatus, may be used instead of the apparatus serving as the information collection source such as the MFP, to record a job history and transmit the recorded job history to the job history processing server 101. More specifically, a program corresponding to the collection agent 404 may be installed into the another network device such as the PC, to operate the collection agent 404 on the another network device.

In the above described exemplary embodiments, the server management unit 504 periodically checks whether the agent management unit 505 has been restored in consideration of the processing efficiency of the request processing unit 501. However, the request processing unit 501 may check whether the agent management unit 505 has been restored every time it receives a reservation for job history transmission.

In the above described exemplary embodiments, the request processing unit 501 confirms whether the agent management unit 505 has been restored, by being triggered by being unable to acquire the agent setting information from the temporary agent management unit 503. Instead of this configuration, the request processing unit 501 may receive a notification that the agent management unit 505 has been restored, from the server management unit 504, and thereby be triggered, to confirm that the agent management unit 505 has been restored.

As described above, according to the exemplary embodiment of the present invention, even if a fault occurs in a management service for managing information about an agent, the job history can be promptly transferred to an external system such as a job history audit system. Thus, the immediacy of an audit of the job history can be maintained.

More specifically, even if a fault in the agent setting information management function used by the job history processing server is prolonged, the job history can be transferred to the job history audit system. Thus, an issue that the immediacy of the audit is deteriorated can be solved.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application 2014-169271, filed Aug. 22, 2014, and No. 2015-011530, filed Jan. 23, 2015, which are hereby incorporated by reference herein in their entirety.

What is claimed is:

1. A management system that accepts data to be collected via a load balancer from an agent, which operates on a network device, comprising:
a receiving unit configured to receive a request to reserve data transfer including identification information about the agent;
a first request unit configured to request first agent information corresponding to the identification information included in the request to reserve data transfer of an agent management service;
a second request unit configured to request second agent information of the network device when the first agent information cannot be acquired from the agent management service;
a storage unit configured to store the second agent information acquired from the network device; and
an export unit configured to export data accepted from the network device after the second agent information is stored, together with the second agent information, to a storage area that can be referred to by an external system.

2. The management system according to claim 1, wherein the load balancer distributes a transfer destination of the data from the agent among a plurality of systems.

3. The management system according to claim 2, wherein a transmission destination of data via the load balancer from the network device of which the second agent information has been requested is fixed to the management system storing the second agent information after the storage unit stores the second agent information.

4. The management system according to claim 3, wherein the fixing of the transmission destination is released when the first agent information can be acquired from the agent management service.

5. The management system according to claim 1, wherein the network device is a printing apparatus, an information processing apparatus capable of collecting the data to be collected from the printing apparatus, or an information processing apparatus that inputs a job to the printing apparatus.

6. The management system according to claim 1, wherein the data to be collected is log information about a job executed by a printing apparatus.

7. The management system according to claim 1, wherein the agent information includes the identification information about the agent, information for specifying a source of the data transmitted by the agent, and setting information about the agent when the agent transmits the data.

8. The management system according to claim 3, wherein the fixing of the transmission destination is released when a start notification from a system other than the management system is received.

9. A method for controlling a management system that accepts data to be collected via a load balancer from an agent, which operates on a network device, the method comprising:
receiving a request to reserve data transfer including identification information about the agent;
making a first request for requesting first agent information corresponding to the identification information included in the request to reserve data transfer of an agent management service;
making a second request for requesting second agent information of the network device when the first agent information cannot be acquired from the agent management service; and
storing the second agent information acquired from the network device; and
exporting data accepted from the network device after the second agent information is stored, together with the second agent information, to a storage area that can be referred to by an external system.
